(19) United States
(12) Patent Application Publication
(10) Pub. No.: US 2015/0189018 A1
(43) Pub. Date: Jul. 2, 2015

(54) EXTREMELY LOW DELAY VIDEO TRANSCODING

(71) Applicant: Limelight Networks, Inc., Tempe, AZ (US)

(72) Inventors: SEAN CASSIDY, Seattle, WA (US); Brandon Smith, Seattle, WA (US); Nicholas Beaudrot, Seattle, WA (US); Huw Morgan, Seattle, WA (US); Michael Asavareungchai, Sammamish, WA (US); Lonhyn Jasinskyj, Tempe, AZ (US); Jason Thibeault, Gilbert, AZ (US)

(73) Assignee: Limelight Networks, Inc., Tempe, AZ (US)

(21) Appl. No.: 14/145,851

(22) Filed: Dec. 31, 2013

(51) Int. Cl. H04L 29/08; H04N 7/01; H04L 29/06

(52) U.S. Cl. CPC H04L 67/1097; H04L 65/602; H04N 7/01

(57) ABSTRACT

A content delivery network transcodes content objects from a content provider for transmission to end users. The content delivery network includes network storage and servers. When a content object is uploaded, the network storage stores a copy of the content object, and a copy of the content object is directed to external file-based storage. At least one of the servers directs segments of the content object to a plurality of transcoding servers. Each of the transcoding servers informs a segment engine about which of the segments the transcoding server has received, transcodes the received segment to form a transcoded segment receivable by at least one of the end users, and transmits the transcoded segment to a permanent storage location. The content delivery network verifies that the copy of the content object is stored in the external file-based storage, and deletes the local copy of the content object.

### BACKGROUND

Video and audio content that is provided over networks (e.g., the Internet) to a variety of end user systems typically must be transcoded into a variety of formats for compatibility with the end user systems. For example, mobile devices often require different video formats than laptop or desktop computers, and different video formats than each other. The need for transcoding introduces a variety of challenges for institutions such as content delivery networks, that store and provide large quantities of content, especially when such content is in high demand.

### SUMMARY

In an embodiment, a content delivery network transcodes content objects from a content provider for transmission to end users. The content delivery network includes network storage and a plurality of servers. When a content object is uploaded from the content provider to the content delivery network, the network storage stores a copy of the content object and a copy of the content object is directed to external file-based storage. At least one of the servers directs segments of the content object to a plurality of transcoding servers. Each of the transcoding servers informs a segment engine about which of the segments the transcoding server has received, transcodes the received segment to form a transcoded segment receivable by at least one of the end users, and transmits the transcoded segment to a permanent storage location. The content delivery network verifies that the copy of the content object is stored in the external file-based storage, and deletes the local copy of the content object.

In an embodiment, method of publishing a content object received from a content provider for distribution to end users includes uploading the content object from the content provider, determining at least one format required by one of the end users, into which the content object should be transcoded, uploading a copy of the content object to external file-based storage and distributing segments of the content object to a plurality of transcoders, while storing local copies of the segments. The method further includes utilizing a segment engine to track which of the transcoders is transcoding which of the segments, and where the local copies of the segments are stored. The method further includes transcoding the segments of the content object into the at least one format, with the transcoders, to form transcoded segments, transmitting the transcoded segments to a permanent storage location, validating that the copy of the content object was uploaded to the external file-based storage, and deleting the local copies of the segments.

In an embodiment, a content delivery network transcodes content objects from a content provider and transmits the transcoded content objects to end users. The content delivery network includes a publisher that receives one of the content objects from the content provider as a digital stream, and forwards the digital stream in real time without intermediate storage. The content delivery network also includes a plurality of transcoders, that receive the digital stream from the publisher and transcode the digital stream in parallel into a corresponding plurality of formats usable by respective ones of the end users, and a storage database that receives the transcoded digital stream to one or more of the end users.

Further areas of applicability of the present disclosure will become apparent from the detailed description provided hereinafter. It should be understood that the detailed description and specific examples below, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 schematically illustrates processing of content from a content provider through a content delivery network to end users.

FIG. 2 schematically illustrates processing of content from a content provider through a content delivery network to end users.

FIG. 3 schematically illustrates a hardware configuration of the content delivery network of FIG. 2.

FIG. 4 schematically illustrates processing of content from a content provider through a content delivery network to end users.

FIG. 5 schematically illustrates processing of content from a content provider through a content delivery network to end users.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides exemplary embodiments only, and is not intended to limit the scope, applicability or configuration of the disclosure. Rather, the description will provide those skilled in the art with an enabling description for implementing embodiments. It is understood that various changes may be made in the function and arrangement of elements without departing from the spirit and scope as set forth in the appended claims.

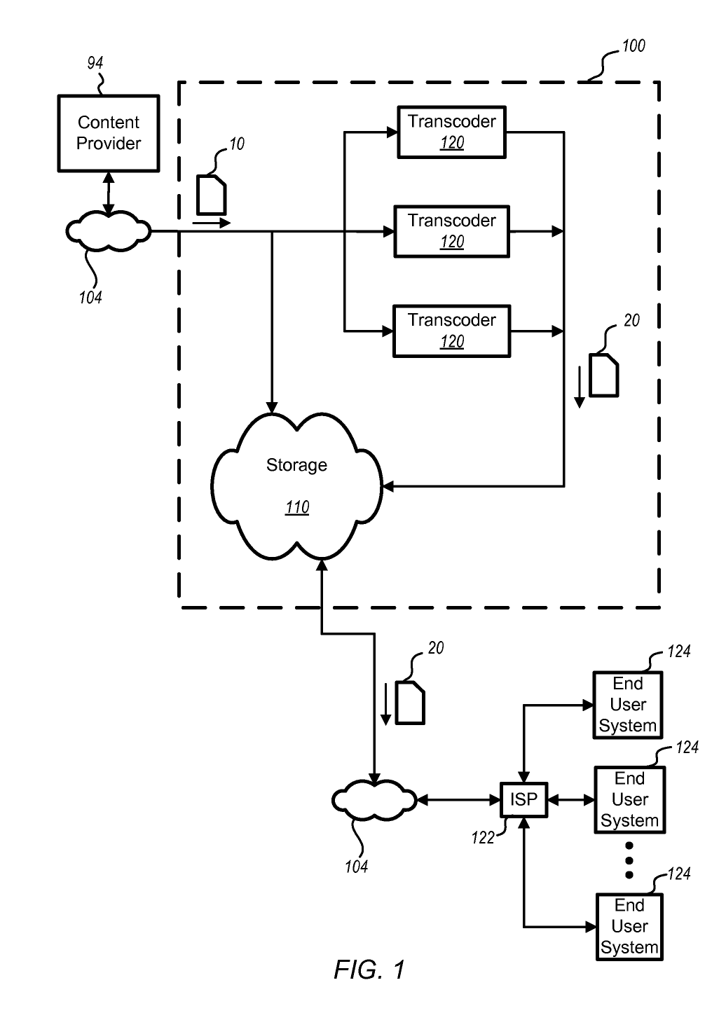

FIG. 1 schematically illustrates processing of content from a content provider 94, through a content delivery network 100, to end users 124. Only certain functional components are shown in FIG. 1, for clarity of illustration. Content provider 94 sends a content object 10 (e.g., a video) by way of Internet 104 to content delivery network 100, where it may be stored in a storage node 110. Either from storage 110, or directly from content provider 94, copies of content object 10 are processed by computers that can translate a content object from one video format to another (known as “transcoders”) 120-1, 120-2, . . . 120-n (i.e., any number of transcoders 120). Transcoders 120 produce transcoded copies 20-1, 20-2, . . . 20-n (i.e., any number of transcoded copies 20) that are passed to and stored in storage 110. Storage 110 may be a single physical storage device for both incoming content object 10 and transcoded copies 20, or may be different physical storage devices; similarly, transcoders 120 may be dedicated devices or functionality provided within one or more servers. Content delivery network 100 may be set up to push content from storage 110 to transcoders 120. In embodiments, content delivery network monitors transcoders 120 (or equivalently, servers that host the transcoding function) to identify transcoders 120 that are a match for the transcoding task in terms of capability and available capacity. Alternatively, in embodiments, transcoders 120 with specific transcoding capabilities may operate with instructions to request material that requires the specific transcoding capability when the transcoder is idle, or below some level of utilization.

Each copy of content object 10 is passed as a complete file to each transcoder 120, and each transcoded copy 20 is passed as a complete file to storage database 150. At this point, content delivery network 100 can “publish” transcoded copies 20, that is, make their availability known both internal to the content delivery network 100 and to end users, e.g., by listing them as available in websites, through user interfaces of streaming services such as Netflix, and the like. Publishing may include generating a “manifest file” that describes features such as the title, size, format, transmission bit rate, universal resource locator (URL) and the like for a given content object, or making the manifest file itself and/or the features described therein visible to end users (e.g., as an item that can be selected for download by clicking in a website). Publishing may also include forwarding a notice of content availability to a notifier that can send notices out to end users, either in response to a previous query from the user, or as an unforced notice (e.g., advertising). When end user systems 124 request the content object (through their respective internet service providers (ISPs) 122, and Internet 104) content delivery network 100 determines what kind of format is required by the requesting end user system 124, and provides the appropriate transcoded copy 20 to serve the request.

A significant concern with the organization described in FIG. 1 is the “time to publish,” that is, the time that elapses between the beginning of transmission of content object 10 by content provider 94, and the visibility and availability of transcoded copies 20 to end users. Transcoding of large content objects 10 can take many seconds or minutes, and even if various transcoders 120 transcode in parallel to provide transcoded copies 20 in various formats, the effect on availability can be substantial from a particular end user's point of view. End users simply do not want to be kept waiting. Another concern is that the organization shown in FIG. 1 may be inflexible with respect to partial file uploads, that is, if content provider 94 is unable to complete a transmission of an entire content object 10, the transmission may have to be restarted from the beginning.

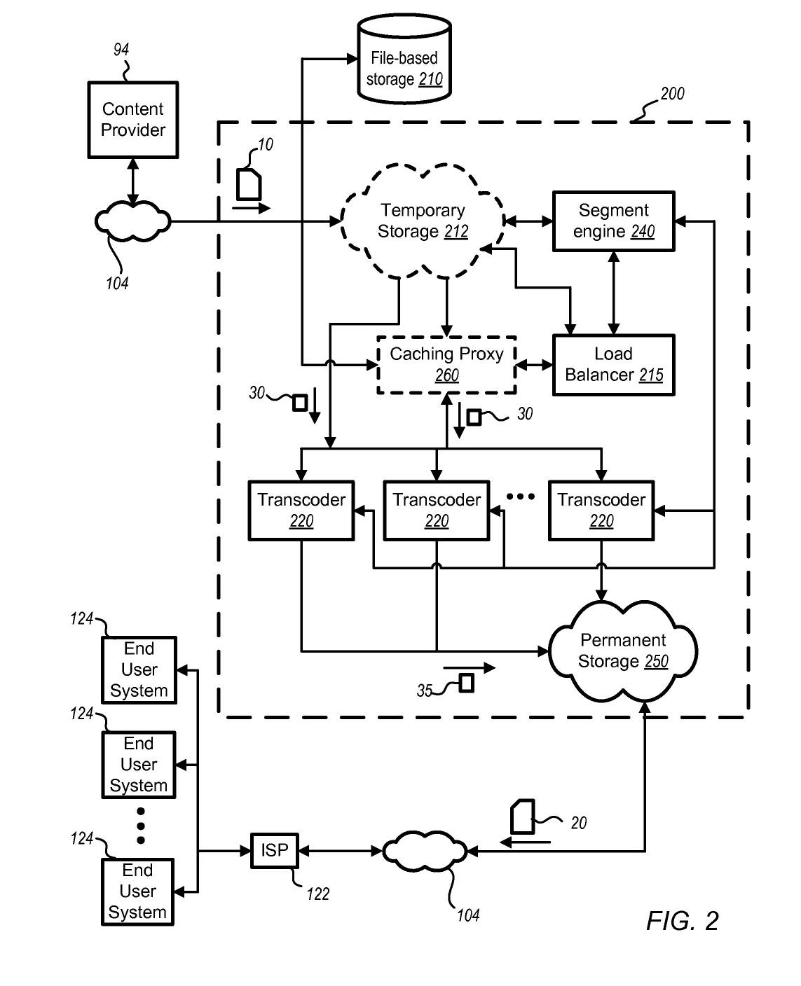

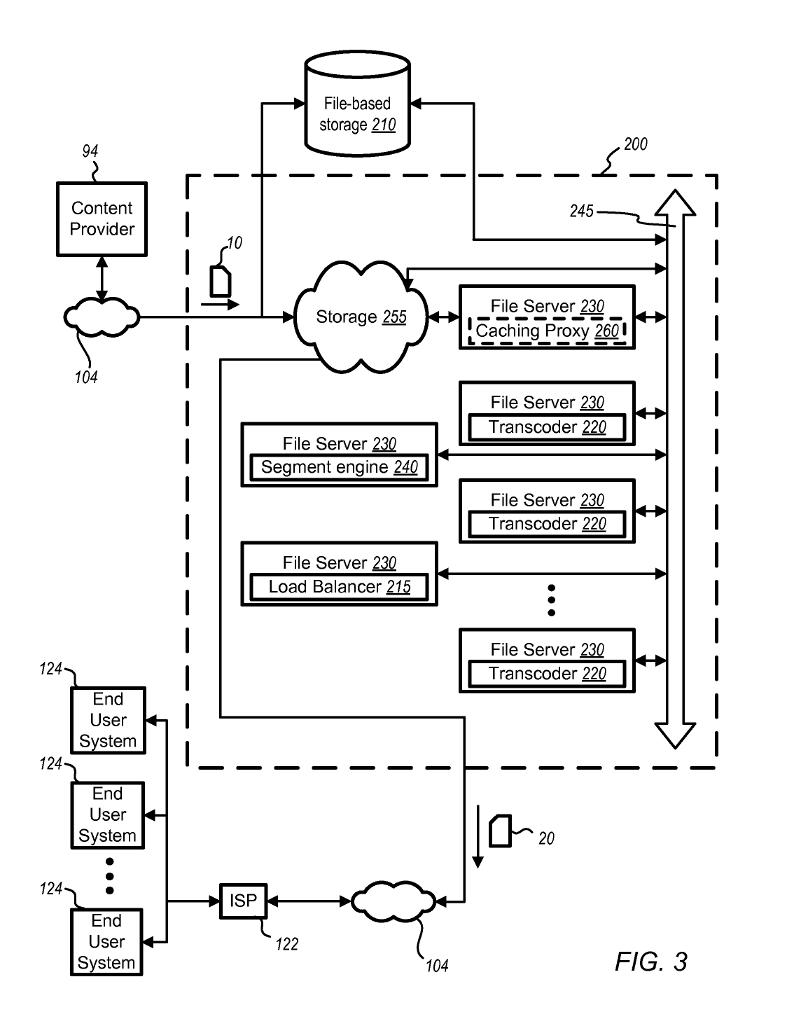

FIG. 2 schematically illustrates processing of content from a content provider 94, through a content delivery network 200, to end users 124. Only certain functional components are shown in FIG. 2, for clarity of illustration. Also, FIG. 2 illustrates interconnection of functional blocks in an exemplary order that the functional blocks pass content objects and segments thereof to one another; FIG. 3 shows an exemplary physical arrangement of hardware configured as the functional components of FIG. 2.

Content provider 94 sends a content object 10 (e.g., a video) by way of Internet 104 to content delivery network 200, where it streams to a file based storage system 210, to temporary storage 212 and/or a caching proxy 260. Temporary storage 212 can be thought of as residing on a storage “cloud” that temporarily or permanently devotes certain amounts of storage for various storage needs. For example, temporary storage 212 may be a storage backbone that is shared across part or all of content delivery network 200. Alternatively, temporary storage 212 may be local storage on one or more file servers. Examples of the file based storage system 210 include Limelight Orchestrate Cloud Storage Service and Amazon S3; storage system 210 does not replicate content object 10 until its upload to file based storage system 210 is complete. Caching proxy 260 is for example a process, running on a file server, that holds a cache of pointers to segments of content object 10.

Transcoders 220 of content delivery network 200 are selected in some manner to receive digital segments 30 of content object 10 for transcoding. In embodiments, a load balancer 215 selects one or more transcoders 220 to receive digital segments 30; temporary storage 212 and/or caching proxy 260 send digital segments 30 to transcoders 220 as directed. Load balancer 215 and/or transcoders 220 may be dedicated devices or functionality provided within one or more file servers. Alternatively, transcoders 220 (or the file servers that host them; see FIG. 3) request material for transcoding when they are idle, or below some level of utilization. Digital segments 30 may be created from a digital stream that corresponds to content object 10 while the stream is being uploaded, without waiting for the stream to completely upload.

As each transcoder 220 begins to receive the stream corresponding to content object 10, it examines the stream for metadata that describes the incoming file format, providing information that is needed for transcoding. For example, metadata that describes frame size, bitrate, codec type, frames per second, audio information and the like may be necessary for a transcoder 220 to understand how the stream of content object 10 is structured. When metadata describing the file is not available at the beginning of the file, operation of system 200 approximates that of system 100 in that the stream corresponding to content object 10 may need to be received in its entirety so that the metadata can be accessed and the file can be processed accordingly.

When metadata describing content object 10 is available at the beginning of the file, load balancer 215 divides content object 10 into digital segments 30, and sends the digital segments 30 to transcoders 220. Digital segments 30 may be divided based on an underlying video format of content object 10 (e.g., frames of an .mp4 file), or may be divided arbitrarily (e.g., each segment may encompass 10 MB, or some other amount, of content). Each transcoder 220 informs a segment server 240 about which digital segments 30 it currently has. Segment server 240 may be a dedicated device or functionality provided within a file server. Load balancer 215 may continue to direct digital segments 30 to the same transcoder 220 or to different transcoders 220. In embodiments, load balancer 215 makes resource allocation decisions based on the metadata and/or complexity of a specific transcoding operation. For example, the metadata may indicate the size of content object 10 such that load balancer 215 can predict, before receiving the remainder of content object 10, a number or type of transcoders 220 that should be allocated to transcoding content object 10. In another example, load balancer 215 assigns low resource amounts to certain transcoding needs (e.g., transcoding a 4 MB video clip from an .mp4 to an .hls format) and greater resource amounts to other transcoding needs (e.g., transcoding a 6 GB, high definition movie from a .wav to an .hds format). In embodiments, load balancer 215 also has information of, and responds to, rules or agreements regarding pricing and/or service levels, between content delivery network 200 and content provider 94 that specify a level of service to be applied to content from content provider 94.

As more of content object 10 streams in and segments thereof are directed to one of transcoders 220, each transcoder 220 updates segment server 240 about which digital segments it has. Load balancer 215 may attempt to keep digital segments 30 of a given content object 10 on a single transcoder 220 or may intentionally distribute digital segments 30 to multiple transcoders 220. Content provider 94 may stop uploading and resume at a later time, such that digital segments 30 are initially loaded to one transcoder 220 and later loaded to a different transcoder 220. In all such cases, segment server receives information of which transcoder 220 has each digital segment 30.

Similarly to content delivery network 100, content delivery network 200 may push content from temporary storage 212 and/or caching proxy 260 to transcoders 220. Alternatively, transcoders 220 may operate with instructions to request material for transcoding when idle or below some level of activity. When transcoders 220 are responsible to request material, segment server 240 sends a message to one or more transcoders 220 when content object 10 begins uploading, to notify them that material is available. When one of the transcoders 220 requests a digital segment 30 of content object 10, segment server 240 locates the appropriate digital segment 30 and initiates its delivery to the transcoder 220. Several transcoders 220 can thus work on different digital segments 30 of a given content object 10 and deliver transcoded digital segments 35 to permanent storage 250. Permanent storage 250 may be a storage cloud and may be the same storage cloud in which temporary storage 210 resides; alternatively, permanent storage 250 may be local storage on one or more file servers. Optional caching proxy serves to reduce network traffic between temporary storage 212 and transcoders 220; functionality of caching proxies is well known.

In embodiments, sequential digital segments 30 of a content object 10 are sent serially to one or more specific transcoders 220 so that discontinuities at beginnings or ends of transcoded digital segments are easily stitched together; load balancer 215 may also direct generation of digital segments 30 with a small amount of overlap between one digital segment 30 and the next so that resulting transcoded digital segments 35 can be easily reassembled into a transcoded content object 20. Segment engine 240 and/or load balancer 215 may preferentially direct sequential digital segments of a content to a specific one of transcoders 220 to facilitate this mode of operation (e.g., as opposed to sending sequential segments of a content object to different transcoders 220).

As soon as a transcoded digital segment 35 corresponding to the beginning of a content object 10 is received at permanent storage 250, content delivery network 200 may publish availability of a transcoded content object 20 corresponding to the entirety of content object 10 in transcoded form. If not all digital segments of content object 10 are transcoded by that time, publishing the availability of transcoded content object 20 risks that later digital segments might not be transcoded and delivered in time to catch up with the first transcoded digital segments. In embodiments, a status indicator or “filler” video clip may follow the initially transcoded digital segments 20 when later digital segments are not transcoded in time for a smooth transition from the initial segments to the later segments. However, it is likely that in the time required for a user to find and request available content object 20, and to stream the first digital segment of content object 20 to the requesting end user system 124, the remaining digital segments of content object 10 can be transcoded and delivered without interruption. In embodiments, a manifest file is updated quickly with information indicating whether only a leading portion, or all, of a content object 20 is available (e.g., incremental updates to the manifest file may be created and released every few seconds).

Publishing may also include “warming up” local caches for quick delivery. In embodiments, this may involve placing an external request for content to the network, thus triggering actual external delivery of the content, ensuring that mechanisms such as caching the content itself, as well as things like DNS addresses for domains or subdomains hosting the content, are ready for end user use. Because a content delivery network typically monitors and charges a content provider per delivery of content, a certain number of external requests for “warm up” purposes may be considered a cost of doing business to the content provider for providing low latency, or the content delivery network may make the requests in such a way that the content provider is not billed for service of such requests.

One or more file servers (for example, any of transcoders 220, caching proxy 260, load balancer 215 and segment engine 240) eventually check to ensure that the incoming content object 10 was completely received and stored within file-based storage system 210, whereupon temporary storage 212 may delete the respective digital segments 30 of content object 10 stored therein. The checking may take the form of comparing a copy of content object 10 built up from the digital segments 30 that were passed down to transcoders 220, with an original (e.g., never broken into segments) copy of content object 10 stored in file-based storage system 210.

FIG. 3 schematically illustrates a hardware configuration of the content delivery network of FIG. 2. As noted above, load balancer 215, transcoders 220, segment engine 240 and/or caching proxy 260 may all be dedicated devices or processes running on file servers. FIG. 3 illustrates each of load balancer 215, transcoders 220, segment engine 240 and caching proxy 260 as processes running on file servers 230. Each file server 230, and storage 255, is connected within the content delivery network via a data connection 245, for example a local area network (LAN) or wide area network (WAN). Transfer of digital segments 30 and transcoded segments 35 occurs via data connection 245 and is not shown in FIG. 3 for clarity of illustration. Storage 255 implements temporary storage 212 and/or permanent storage 250 as shown in FIG. 2, but as also noted above, some temporary storage may also be available on storage devices (e.g., hard drives, random access memory (RAM), Flash memory and the like) of file servers 230.

It is also understood that components of content delivery network 200 may be distributed over multiple points of presence (POPs) that are geographically distributed, so that end users' requests for content can be directed to local POPs for low latency in service of content to the end users. Geographic distribution of POPs, and variations in demand for certain output formats according to geography, may affect decisions about transcoding priority. For example, if a given POP or group of POPs concentrated in a particular region are experiencing high demand for content associated with one or more output formats (e.g., various formats that would be associated with iOS based devices) then the given POP or group of POPs may choose to prioritize transcoding into the one or more output formats. Conversely, if another POP or group of POPs concentrated in another region are not experiencing any demand for files in certain formats, transcoders in those POPs may be tasked with other jobs. Therefore, a small number of users requesting content in one format, that would usually be served by a POP in their vicinity, may be directed to a POP that is geographically distant if the POP in their vicinity is busy with demand for content in other formats. Priority decisions can also be made based on arrangements between CDN 200 and content provider 94, e.g., resources can be dedicated and/or preferentially applied by CDN 200 if an agreement between CDN 200 and content provider 94 mandates it. Such arrangements may be reflected in the cost of transcoding, that is, CDN 200 may realize higher payment from content provider 94 in exchange for providing such resources. This amounts to content provider 94 paying CDN 200 more to provide a better end user experience for content provider 94's content.

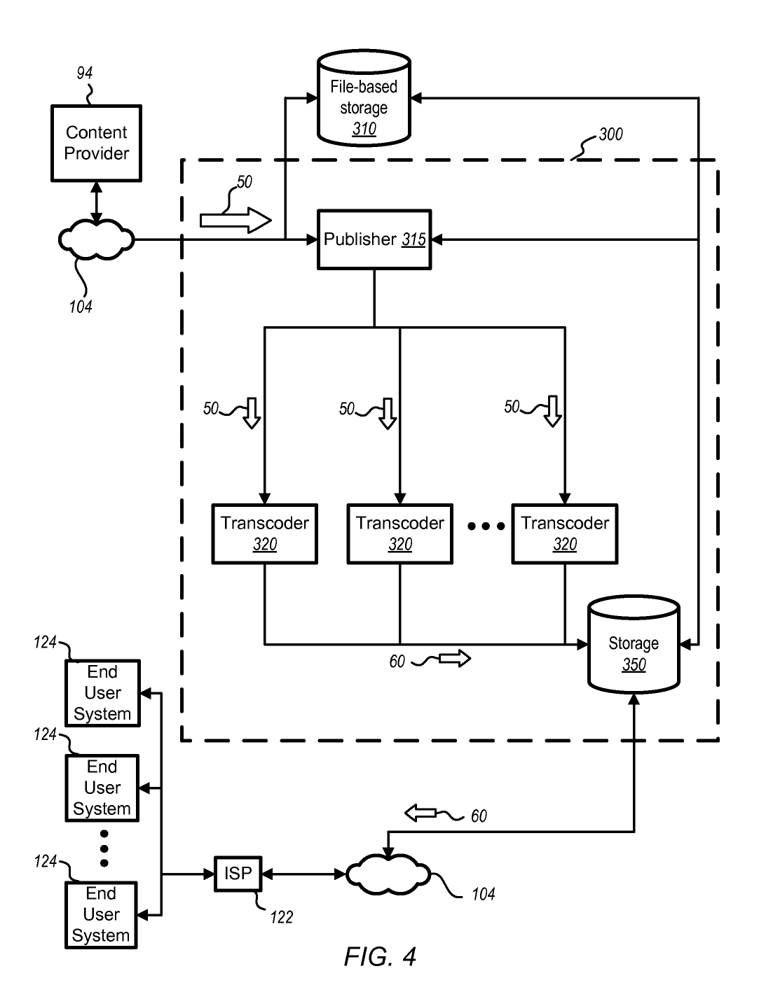

FIG. 4 schematically illustrates processing of content from a content provider 94, through a content delivery network 300, to end users 124. Only certain functional components are shown in FIG. 4, for clarity of illustration.

Content delivery network 300 utilizes a publish-subscribe architecture to transcode streams of content as fast as they can pass through the components thereof (e.g., the only delay in time to publish is the delay that a single bit takes to move through the system). Content provider 94 sends a content object (e.g., a video) by way of Internet 104 to content delivery network 200 as a stream 50 that is simultaneously sent to a file based storage system 310 and a publisher 215. Examples of the file based storage system 310 include Limelight Orchestrate Cloud Storage Service and Amazon S3. Publisher 215 forwards stream 50 to one or more subscriber transcoders 320 (e.g., as many subscriber transcoders 320 as are designated to transcode stream 50 into various required formats). Transcoders 320 transcode stream 50 without storing it, and send their output as transcoded streams 60 to storage 350. Publisher 315 immediately publishes the content object. Content delivery network 300 can, in embodiments, begin streaming one or more of transcoded streams 60 to respective end users before transcoded streams 60 are fully received by storage 350, and even before input stream 50 is fully received by publisher 315 or transcoders 320.

FIG. 4 designates components of content delivery network 300 according to their functionality; it is to be understood that transcoders 320 and publisher 315 may be dedicated devices or may be processes implemented on file servers, and storage 350 may be implemented using general purpose storage, in similar manner as components of content delivery network 300 are shown in FIG. 3 as specific implementations of file servers and general storage. In embodiments, content delivery network 300 streams copies of stream 50 to geographically distributed points of presence (POPs) that, in turn, stream copies of stream 50 to multiple transcoders 320 within each POP for transcoding into the various required formats. Distribution of the transcoding function across formats and geographical areas, optionally with the caching techniques discussed above to “warm up” local services for quick delivery, provide a near zero time to publish for each format across geographical markets.

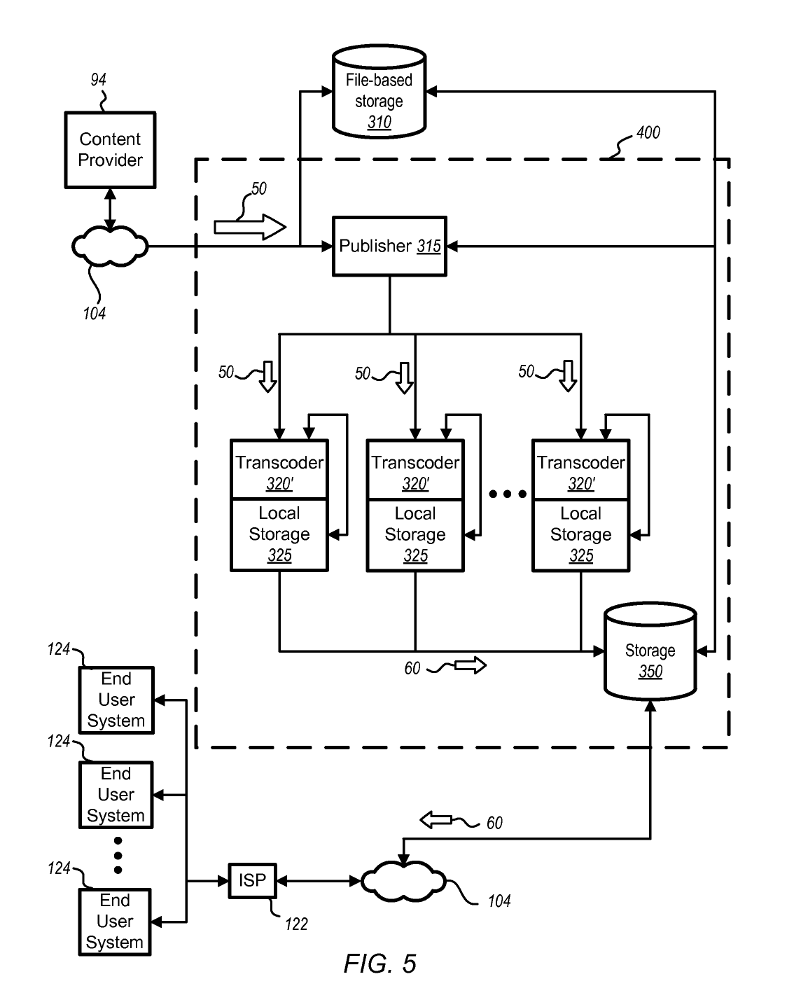

FIG. 5 schematically illustrates processing of content from a content provider 94, through a content delivery network 400, to end users 124. Only certain functional components are shown in FIG. 5, for clarity of illustration.

Content delivery network 400 utilizes the publish-subscribe architecture to transcode streams of content as fast as they can pass through the components thereof. Content delivery network 400 has components that are similar to those of content delivery network 300, FIG. 3, but supports two pass transcoding through the use of local storage, as now described. In content delivery network 400, transcoders 320′ perform a streaming first pass transcode of streams 50, writing the content object and metadata generated in the first pass to local storage 325. In a second pass, transcoders 320′ read back the content object and the metadata, and stream the output to storage database 350. Two pass encoding may be done for example to allocate an appropriate number of digital bits in a transcoded format to match an average specified bitrate (e.g., to keep a transmission bandwidth within reasonable limits).

In embodiments, a content delivery network (e.g., any of content delivery networks 100, 200, 300, 400) may include geographically distributed resources, optionally organized into POPs, across which content is distributed, to reduce latency experienced by end users 124 when content is requested. It is contemplated that any of the system resources herein, such as the file-based storage, incoming databases, file servers, transcoders, load balancers, caching proxies, segment servers, publishers, local storage and storage databases may be centrally located or may be distributed geographically, e.g., at the “edge” of the network (the part closest to end users, in latency and/or geographically). Similarly, a content delivery network may have knowledge of likely correlations between geographic locations and demand for certain content and/or download formats, and transcoding tasks as described herein may be directed to and carried out in parts of the content delivery network where demand is expected for a given content object or format.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments. It is contemplated that as necessary, functionality of the items identified herein may be provided by specially designed electronic hardware or by software executing on electronic hardware.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the terms “memory” and/or “storage medium” may represent one or more memories for storing data, including read only memory (ROM), static or dynamic random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of publishing a content object received from a content provider for distribution to end users, comprising:
uploading the content object from the content provider;
determining at least one format required by one of the end users, into which the content object should be transcoded;
uploading a copy of the content object to external file-based storage;
distributing segments of the content object to a plurality of transcoders, while storing local copies of the segments;
utilizing a segment engine to track:
which of the transcoders is transcoding which of the segments, and
where the local copies of the segments are stored;
transcoding the segments of the content object into the at least one format, with the transcoders, to form transcoded segments;
transmitting the transcoded segments to a permanent storage location;
validating that the copy of the content object was uploaded to the external file-based storage; and
deleting the local copies of the segments.

2. The method of publishing a content object received from a content provider for distribution to end users as recited in claim 1, further comprising assembling the transcoded segments to form a transcoded content object.

3. The method of publishing a content object received from a content provider for distribution to end users as recited in claim 2, further comprising placing an external request for the transcoded content object, wherein placing the external request causes a DNS system to cache a DNS address of a domain hosting the transcoded content object.

4. The method of publishing a content object received from a content provider for distribution to end users as recited in claim 3, wherein the content provider is not billed for the external request.

5. The method of publishing a content object received from a content provider for distribution to end users as recited in claim 1, wherein:
determining the at least one format required by the one of the end users comprises determining a number of differing formats into which the content object is to be transcoded;
distributing the segments of the content object to the plurality of transcoders comprises distributing each segment to a number of transcoders that is equal to the number of differing formats;
utilizing the segment engine comprises utilizing the segment engine to track each segment that is distributed to each of the number of transcoders; and
transcoding the segments of the content object comprises utilizing the number of transcoders to transcode the segments.

6. The method of publishing a content object received from a content provider for distribution to end users as recited in claim 1, wherein distributing the segments of the content object to the plurality of transcoders comprises utilizing a load balancer to divide the content object into the segments.

7. The method of publishing a content object received from a content provider for distribution to end users as recited in claim 6, wherein the load balancer utilizes one or more of metadata of the content object, complexity of a transcoding operation required, and terms of an agreement with the content provider to determine a number of the transcoders that should be allocated for the step of transcoding.

8. The method of publishing a content object received from a content provider for distribution to end users as recited in claim 1, wherein distributing the segments of the content object to the plurality of transcoders comprises utilizing a caching proxy to:
store one of the segments, and
distribute the one of the segments to two or more of the transcoders.

9. A content delivery network that transcodes content objects from a content provider for transmission to end users, the content delivery network comprising:
network storage; and
a plurality of servers;
wherein when a content object is uploaded from the content provider to the content delivery network:
the network storage stores a copy of the content object;
a copy of the content object is directed to external file-based storage;
at least one of the servers directs segments of the content object to a plurality of transcoding servers, wherein each of the transcoding servers:
informs a segment engine about which of the segments the transcoding server has received,
transcodes the received segment to form a transcoded segment receivable by at least one of the end users, and
transmits the transcoded segment to a permanent storage location;
the content delivery network:
verifies that the copy of the content object is stored in the external file-based storage, and
deletes the local copy of the content object.

10. The content delivery network that transcodes content objects from a content provider for transmission to end users of claim 9, wherein at least two of the plurality of transcoding servers transcode into differing output formats from one another, copies of the digital segments are received by at least the two of the plurality of transcoding servers, and the two of the plurality of transcoding servers transmit respectively transcoded digital segments to the storage database for assembly into at least two transcoded content objects having the differing output formats.

11. The content delivery network that transcodes content objects from a content provider for transmission to end users of claim 9, wherein a load balancer divides the one of the content objects into the digital segments and transmits the digital segments to the transcoding servers.

12. The content delivery network that transcodes content objects from a content provider for transmission to end users of claim 11, further comprising a caching proxy that receives the one of the content objects from the load balancer, divides the one of the content objects into the digital segments and transmits the digital segments to the transcoding servers.

13. The content delivery network that transcodes content objects from a content provider for transmission to end users of claim 11, wherein at least one of the transcoding servers sends a request to the load balancer for material for transcoding.

14. The content delivery network that transcodes content objects from a content provider for transmission to end users of claim 11, wherein the load balancer utilizes one or more of metadata of the content object, complexity of a transcoding operation required, and terms of an agreement with the content provider to determine a minimum number of the transcoders to be used as the plurality of transcoding servers.

15. A content delivery network that transcodes content objects from a content provider and transmits the transcoded content objects to end users, the content delivery network comprising:
a publisher that receives one of the content objects from the content provider as a digital stream, and forwards the digital stream in real time without intermediate storage thereof;
a plurality of transcoders that:
receive the digital stream from the publisher and
transcode the digital stream in parallel into a corresponding plurality of formats usable by respective ones of the end users; and
a storage database that receives the transcoded digital stream for redistribution to one or more of the end users.

16. The content delivery network that transcodes content objects from a content provider and transmits the transcoded content objects to end users as recited in claim 15, wherein the storage database is configured to redistribute a copy of the transcoded digital stream in real time such that the transcoded digital stream begins to stream out to the one or more of the end users before it is completely received by the storage database.

17. The content delivery network that transcodes content objects from a content provider and transmits the transcoded content objects to end users as recited in claim 15, wherein two or more of the plurality of transcoders reside in different points of presence that are located in differing geographic areas.

18. The content delivery network that transcodes content objects from a content provider and transmits the transcoded content objects to end users as recited in claim 15, wherein at least one of the transcoders:
performs a streaming first pass transcode of the digital stream;
writes the content object and metadata generated in the first pass transcode to local storage of the at least one of the transcoders;
reads back the content object and the metadata; and
streams the output to the storage database.
